(19) United States
(12) Patent Application Publication
(10) Pub. No.: US 2026/0063206 A1
(43) Pub. Date: Mar. 5, 2026

(54) Sealing Structure

(71) Applicant: ZHEJIANG SANOU MACHINERY CO. LTD., Taizhou (CN)

(72) Inventors: Xuebiao TONG, Taizhou (CN); Weineng WANG, Taizhou (CN); Peng TAO, Taizhou (CN); Zhengqing LIN, Taizhou (CN)

(21) Appl. No.: 19/314,209

(22) Filed: Aug. 29, 2025

(30) Foreign Application Priority Data
Sep. 2, 2024 (CN) 202422145649.4

(51) Int. Cl. F16J 15/3268; F16J 15/3284; F16J 15/34

(52) U.S. Cl. CPC F16J 15/3268; F16J 15/3284; F16J 15/3484

(57) ABSTRACT

The present invention provides a sealing structure, comprising a solid regular-shaped sealing ring and a second sealing ring. The inner surface of the second sealing ring is provided with a mounting groove for the solid regular-shaped sealing ring, and the outer surface is provided with an annular protrusion to form a sealing fit with a sealing mating surface. The solid regular-shaped sealing ring is softer than the second sealing ring, and clearance gaps are provided between the two sidewalls of the mounting groove and the solid regular-shaped sealing ring, allowing the solid regular-shaped sealing ring to freely deform toward both sides when subjected to pressure. A groove is further provided at the centerline of the bottom of the mounting groove. The sealing structure of the present invention can be applied in various scenarios such as oil cylinders, and is capable of ensuring sealing performance while controlling the friction between sealing mating surfaces, thereby preventing excessive friction. In addition, it improves the internal structure of the composite sealing ring and enhances sealing stability during reciprocating motion.

### TECHNICAL FIELD

The present invention relates to a sealing structure.

### BACKGROUND

At present, sealing structures of oil cylinders generally adopt solutions that use O-rings alone, such as single O-rings or double O-rings. For such sealing solutions, in order to achieve better sealing performance, it is difficult to control the fit between the sealing mating surfaces. This often leads to excessive friction, which may easily cause the O-ring to be dislodged from the mounting groove, resulting in seal failure. Alternatively, excessive heat generation may occur, affecting the service life. Some designs employ composite sealing rings in an attempt to ensure sealing performance while avoiding excessive friction. However, the internal fit of the composite sealing rings still requires improvement.

### SUMMARY

The objective of the present invention is to provide a sealing structure that employs a composite sealing ring, which can be applied in various scenarios such as oil cylinders. This structure ensures sealing performance while controlling the friction between the sealing mating surfaces, thereby preventing excessive friction. At the same time, it improves the internal structure of the composite sealing ring to enhance sealing stability during reciprocating motion.

To achieve the above, the present invention adopts the following technical solution:

A sealing structure, comprising a solid regular-shaped sealing ring and a second sealing ring, the second sealing ring is provided with an outer surface and an inner surface, the inner surface is provided with a mounting groove for the solid regular-shaped sealing ring, and the outer surface is provided with an annular protrusion to form a sealing fit with the sealing mating surface; in the free state, the solid regular-shaped sealing ring protrudes from the mounting groove for the solid regular-shaped sealing ring, the solid regular-shaped sealing ring is softer than the second sealing ring, moreover, clearance gaps are provided between both sidewalls of the mounting groove for the solid regular-shaped sealing ring and the solid regular-shaped sealing ring itself, allowing the solid regular-shaped sealing ring to freely deform toward both sides under pressure, and a groove is provided at the centerline of the bottom of the mounting groove for the solid regular-shaped sealing ring.

Based on the above technical solution, the present invention may further adopt the following additional technical solutions, either individually or in combination:

The second sealing ring is further provided with side surfaces located between the inner surface and the outer surface, wherein the side surfaces are configured to form an anti-displacement fit with the mounting groove of the sealing structure.

The cross-sectional body of the second sealing ring is rectangular, the annular protrusion is arranged on its outer contour, and the mounting groove for the solid regular-shaped sealing ring is arranged on its inner contour, the two right-angle edges on both sides form an anti-displacement fit with the mounting groove having a rectangular cross-section.

The sealing structure is disposed within an annular groove on the inner side or the outer periphery of a component.

The cross-sectional shape of the solid regular-shaped sealing ring is O-shaped or elliptical.

The bottom of the mounting groove for the solid regular-shaped sealing ring is of concave arc shape or flat, and the concave arc shape is symmetrical with respect to the groove located at the centerline of the groove bottom.

The groove located at the centerline of the groove bottom has a cross-sectional shape such as a V-shape, a concave arc shape, or a rectangular shape.

The solid regular-shaped sealing ring forms a sealing fit with the bottom of the mounting groove in the sealing structure.

The side surface of the second sealing ring is configured to form a sealing fit with the groove wall of the mounting groove in the sealing structure.

By adopting the technical solution of the present invention, the invention provides the following advantages:
1. The sealing structure of the present invention has good versatility, can be used in both hydraulic and pneumatic equipment, supports bidirectional sealing, and is easy to install;
2. When excessive friction may occur, the deformation of the solid regular-shaped sealing ring can absorb excess energy to ensure that the friction force between the second sealing ring and the sealing mating surface meets the requirements, thereby preventing the sealing ring from being dislodged from the mounting groove, causing sealing failure, or generating severe heat that affects service life;
3. The present invention provides deformation spaces on both sides of the solid regular-shaped sealing ring, so that the deformation of the solid regular-shaped sealing ring is fully ensured, and good sealing performance is achieved under both low and high pressure conditions;
4. It can improve the positional stability between the second sealing ring and the solid regular-shaped sealing ring and the sealing performance between them and the mating surfaces, ensuring stable sealing performance during bidirectional reciprocating motion;
5. It features low friction, low starting resistance, and smooth motion.

### BRIEF DESCRIPTION OF THE DRAWINGS

FIG. 1 is a schematic view of Embodiment 1 of the present invention.

FIG. 2 is a schematic view of Embodiment 2 of the present invention.

FIG. 3 is a sectional view showing Embodiment 1 of the present invention in a free state during use.

FIG. 4 is a sectional view showing Embodiment 1 of the present invention in a compressed state during use.

FIG. 5 is a sectional view showing Embodiment 2 of the present invention in a free state during use.

FIG. 6 is a sectional view showing Embodiment 2 of the present invention in a compressed state during use.

FIG. 7 is a schematic view of Embodiment 3 of the present invention.

FIG. 8 is a schematic view of Embodiment 4 of the present invention.

FIG. 9 is a schematic view of Embodiment 5 of the present invention.

FIG. 10 is a schematic view of Embodiment 6 of the present invention.

FIG. 11 is a sectional view of the structural embodiment when the present invention is applied to a rotary oil cylinder.

### DETAILED DESCRIPTION

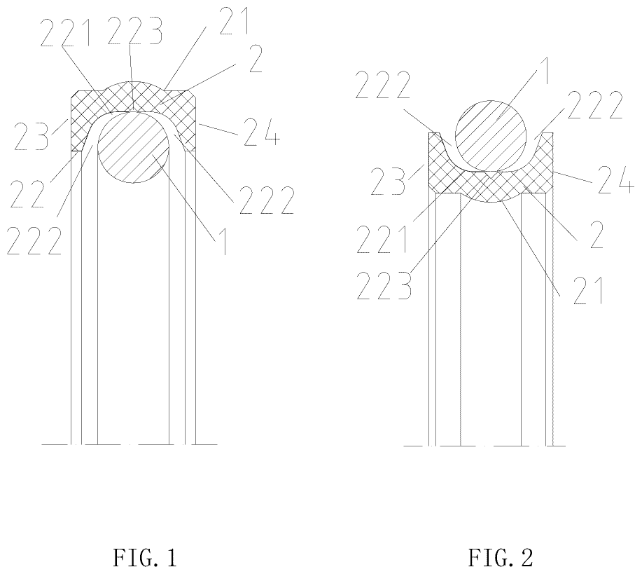

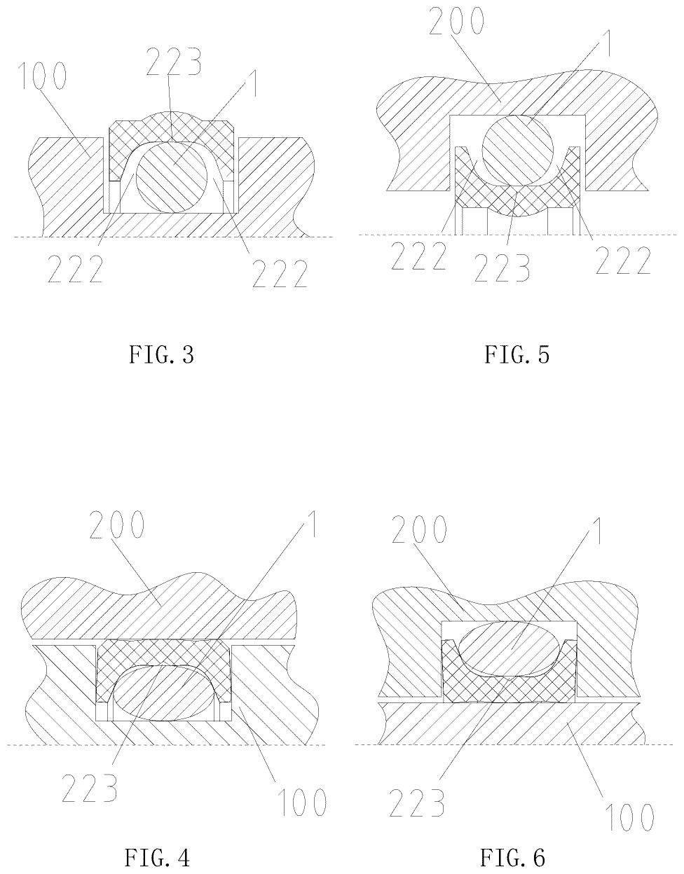

Embodiment 1: Shaft-mounted sealing structure with reference to FIGS. 1, 3, 4, and 11

A sealing structure provided in this embodiment comprises a solid regular-shaped sealing ring 1 and a second sealing ring 2; the second sealing ring 2 is provided with an outer surface 21, an inner surface 22, and side surfaces 23 and 24 located between the inner surface 22 and the outer surface 21; the inner surface 22 is provided with a mounting groove 221 for the solid regular-shaped sealing ring, and the outer surface 21 is provided with an annular protrusion 211, which forms a sealing fit with a sealing mating surface.

In the free state, the solid regular-shaped sealing ring 1 protrudes from the mounting groove 221, and the solid regular-shaped sealing ring 1 is softer than the second sealing ring 2; during installation, the sealing structure is primarily compressed between the hole and the shaft through the deformation of the solid regular-shaped sealing ring 1, which allows control of the friction between the second sealing ring 2 and the sealing mating surface (in this embodiment, the sealing structure is mounted on the shaft 100, and the sealing mating surface is the hole wall 200).

The second sealing ring 2 has a larger size than the solid regular-shaped sealing ring 1, which also enhances its resistance to being dislodged from the mounting groove 101 of the sealing structure, and the solid regular-shaped sealing ring 1 is positioned between the second sealing ring 2 and the bottom of the mounting groove of the sealing structure, thereby preventing it from being dislodged; the solid regular-shaped sealing ring 1 forms a sealing fit with the bottom of the mounting groove of the sealing structure on the shaft.

Moreover, clearance gaps 222 are provided between both sidewalls of the mounting groove 221 and the solid regular-shaped sealing ring 1, allowing the solid regular-shaped sealing ring 1 to freely and preferentially deform toward both sides under pressure; additionally, a groove 223 is provided at the centerline of the bottom of the mounting groove 221, and the groove 223 has a V-shaped cross-section.

The groove 223 serves as a positioning structure for the solid regular-shaped sealing ring 1, improving its positional stability in the free state, compressed state, and during bidirectional motion, thereby enhancing the sealing performance, while also avoiding stress concentration under excessive compression of the second sealing ring 2, which could otherwise affect its service life.

The bottom of the mounting groove 221 for the solid regular-shaped sealing ring is of concave arc shape, and the concave arc shape is symmetrical with respect to the groove 223.

The side surfaces 23 and 24 are configured to form an anti-displacement fit with the mounting groove of the sealing structure; for example, the cross-sectional body of the second sealing ring may be rectangular. When the cross-sectional body of the second sealing ring is rectangular, the inner contour thereof is provided with the mounting groove 221 for the solid regular-shaped sealing ring, and the two right-angle sides form an anti-displacement fit with the mounting groove of the sealing structure. The mounting groove of the sealing structure preferably has a rectangular cross-sectional shape.

Furthermore, the side surfaces 23 and 24 of the second sealing ring 2 are configured to form a sealing fit with the groove wall of the mounting groove of the sealing structure.

The cross-sectional shape of the solid regular-shaped sealing ring 1 is O-shaped, and the material of the solid regular-shaped sealing ring 1 may be selected from NBR (nitrile rubber) or FKM (fluororubber); the material of the second sealing ring 2 may be selected from PTFE (polytetrafluoroethylene) or UPE (ultra-high molecular weight polyethylene).

The mounting groove of the sealing structure preferably has a rectangular cross-sectional shape. The second sealing ring 2 is preferably configured such that its cross-sectional body is rectangular, with the annular protrusion 211 provided on its outer contour, and the mounting groove 221 for the solid regular-shaped sealing ring provided on its inner contour, while the two right-angle sides thereof form an anti-displacement fit with the mounting groove having a rectangular cross-sectional shape.

Embodiment 2: Hole-mounted sealing structure with reference to FIGS. 2, 5, and 6

The structure of this embodiment is similar to that of Embodiment 1, except that it is a sealing structure mounted on the hole wall, with the sealing mating surface being the shaft surface. In FIG. 2, reference numerals identical to those in FIG. 1 denote the same elements.

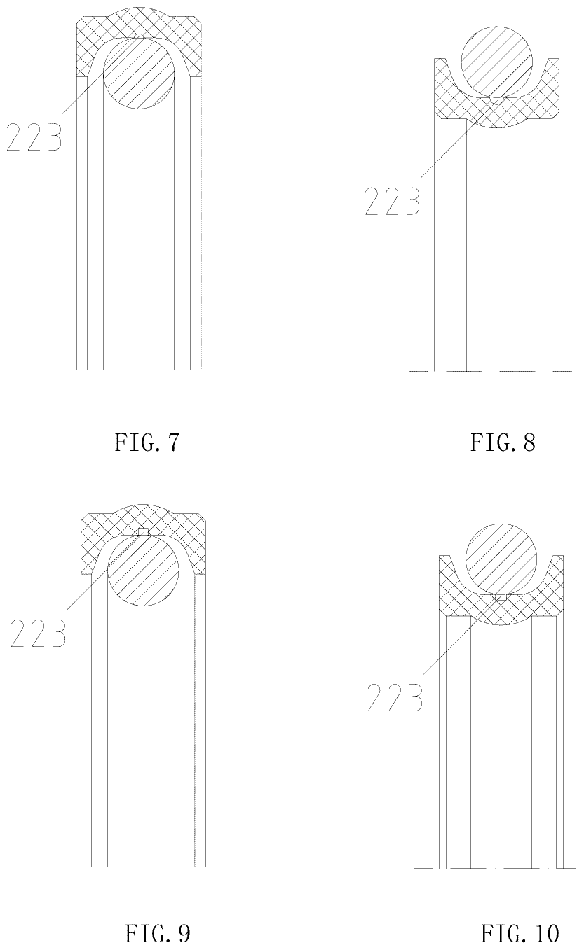

Embodiment 3: Shaft-mounted sealing structure with reference to FIG. 7

In this embodiment, the groove 223 is in the form of a circular arc, and other structural features refer to Embodiment 1.

Embodiment 4: Hole-mounted sealing structure with reference to FIG. 8

In this embodiment, the groove 223 is in the form of a circular arc, and other structural features refer to Embodiment 2.

Embodiment 5: Shaft-mounted sealing structure with reference to FIG. 9

In this embodiment, the groove 223 has a rectangular shape, and other structural features refer to Embodiment 1.

Embodiment 6: Hole-mounted sealing structure with reference to FIG. 10

In this embodiment, the groove 223 has a rectangular shape, and other structural features refer to Embodiment 2.

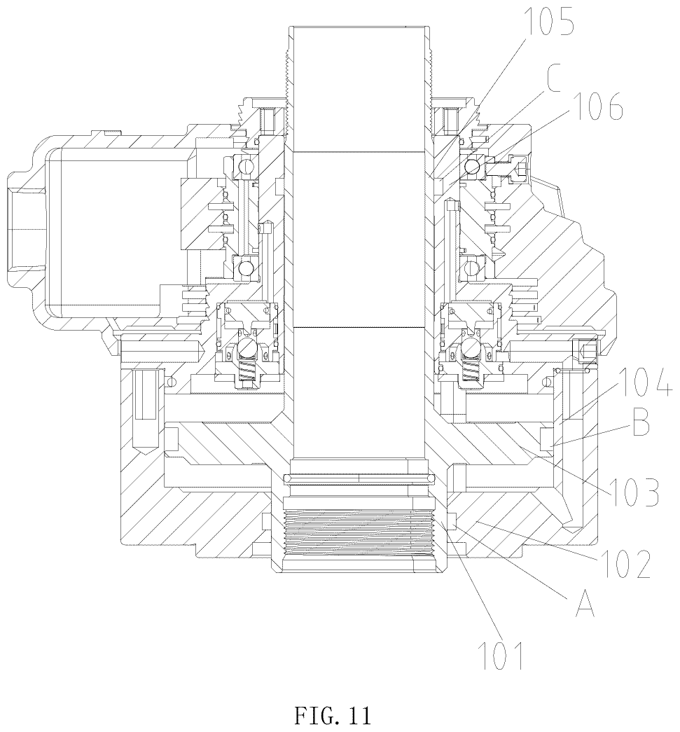

As shown in FIG. 11, the sealing structure of the present invention is used as the sealing structure of a rotary oil cylinder, and the installation positions include the following:
(1) Between the outer wall of the front end 101 of the piston and the inner wall of the front end 102 of the cylinder body, designated as position A in FIG. 11, which is a hole-mounted sealing structure;
(2) Between the outer wall of the piston disc body 103 and the inner wall of the rear end 104 of the cylinder body, designated as position B in FIG. 11, which is a shaft-mounted sealing structure;
(3) Between the outer wall of the rear end 105 of the piston and the inner wall of the rear portion 106 of the cylinder cover, designated as position C in FIG. 11, which is a hole-mounted sealing structure.

The above description is merely specific embodiments of the present invention and should not be construed as limiting the structural features of the invention; any modifications or alterations made by those skilled in the art within the scope of the present invention shall be included within the scope of protection of the invention.

It should be noted that the terms “comprise” and “have” as well as any variations thereof in the specification, claims, and above drawings of the present invention are intended to cover non-exclusive inclusion. The terms “install,” “provide,” “be provided with,” “connect,” “be connected,” and “sleeve-fit” shall be interpreted broadly. For example, they may refer to fixed connections, detachable connections, or integral structures; they may refer to mechanical connections or electrical connections; they may refer to direct connections or indirect connections through intermediate media; or they may refer to internal communication between two devices, components, or elements. Those skilled in the art can understand the specific meanings of the above terms in the present invention in light of the specific context.

In the description of the present invention, it should be understood that terms such as “one end,” “the other end,” “outer side,” “inner side,” “horizontal,” “end portion,” “length,” “outer end,” “left,” and “right” refer to orientations or positional relationships based on the accompanying drawings, and are used only for the purpose of simplifying the description of the present invention and facilitating understanding thereof, rather than indicating or implying that the referenced devices or components must have a specific orientation or be constructed and operated in a specific orientation. Therefore, such expressions should not be construed as limitations to the present invention. The use of terms such as “first” and “second” is only intended for descriptive convenience and does not imply any order or relative importance.

1. A sealing structure, comprising a solid regular-shaped sealing ring and a second sealing ring, characterized in that, the second sealing ring is provided with an outer surface and an inner surface, the inner surface is provided with a mounting groove for the solid regular-shaped sealing ring, the outer surface is provided with an annular protrusion to form a sealing fit with a sealing mating surface,
in a free state, the solid regular-shaped sealing ring protrudes from the mounting groove for the solid regular-shaped sealing ring,
the solid regular-shaped sealing ring is softer than the second sealing ring,
and clearance gaps are provided between the two sidewalls of the mounting groove for the solid regular-shaped sealing ring and the solid regular-shaped sealing ring itself, so that the solid regular-shaped sealing ring can freely deform toward both sides when compressed,
and a groove is provided at the centerline of the bottom of the mounting groove for the solid regular-shaped sealing ring.

2. The sealing structure according to claim 1, characterized in that the second sealing ring is further provided with side surfaces located between the inner surface and the outer surface, wherein the side surfaces are configured to form an anti-displacement fit with the mounting groove of the sealing structure.

3. The sealing structure according to claim 1, characterized in that the cross-sectional body of the second sealing ring is rectangular, wherein the annular protrusion is provided on its outer contour, the mounting groove for the solid regular-shaped sealing ring is provided on its inner contour, and the two right-angle sides thereof form an anti-displacement fit with the mounting groove having a rectangular cross-section.

4. The sealing structure according to claim 1, characterized in that the sealing structure is disposed within an annular groove on the inner side or the outer periphery of a component.

5. The sealing structure according to claim 1, characterized in that the cross-sectional shape of the solid regular-shaped sealing ring is O-shaped or elliptical.

6. The sealing structure according to claim 1, characterized in that the bottom of the mounting groove for the solid regular-shaped sealing ring is of concave arc shape or flat shape, and the concave arc shape is symmetrical with respect to the groove provided at the centerline of the groove bottom.

7. The sealing structure according to claim 1, characterized in that the groove provided at the centerline of the groove bottom has a cross-sectional shape of V-shape, concave arc shape, or rectangular shape.

8. The sealing structure according to claims 1, characterized in that the solid regular-shaped sealing ring forms a sealing fit with the bottom of the mounting groove of the sealing structure.

9. The sealing structure according to claim 2, characterized in that the side surface of the second sealing ring is configured to form a sealing fit with the groove wall of the mounting groove of the sealing structure.
